(19) United States
(12) Patent Application Publication
(10) Pub. No.: US 2006/0221965 A1
(43) Pub. Date: Oct. 5, 2006

(54) Method of transferring data packets in a communications network

(76) Inventors: Peter Bosch, New Providence, NJ (US); Sape J. Mullender, North Plainfield, NJ (US); Girija Narlikar, Jersey City, NJ (US)

Correspondence Address: HARNESS, DICKEY & PIERCE, P.L.C., P.O. BOX 8910, RESTON, VA, 20195, US

(21) Appl. No.: 11/094,430

(22) Filed: Mar. 31, 2005

(51) Int. Cl. H04L 12/28

(52) U.S. Cl. 370/392; 370/394

(57) ABSTRACT

In a method of communication, a first type of data packet is received. The first type of data packet is at least a portion of a second type of data packet. Based on the received first type of data packet, a determination is made as to whether to expect receipt of a subsequent first type of data packet in a given time interval. A status signal is sent if the subsequent first type of data packet is not received in the given time interval as determined in the determining step. In another method of communication, a data packet is received at a physical layer over a circuit switched physical channel. A status of the data packet is determined at the physical layer. A status report is sent to a higher protocol layer based on the determination.

### BACKGROUND OF THE INVENTION

1. Field of the Invention

The present invention relates generally to a method of transferring data packets in a communications network, and more particularly to a method increasing the efficiency of data packet transfer in a communications network.

2. Description of the Related Art

A cellular communications network typically includes a variety of communication nodes coupled by wireless or wired connections and accessed through different types of communications channels. Each of the communication nodes includes a protocol stack that processes the data transmitted and received over the communications channels. Depending on the type of communications system, the operation and configuration of the various communication nodes can differ and are often referred to by different names. Such communications systems include, for example, a Code Division Multiple Access 2000 (CDMA2000) system and Universal Mobile Telecommunications System (UMTS).

UMTS is a wireless telephony standard which describes a set of protocol standards. For example UMTS sets forth the protocol standards for the transmission of voice and data between a base station (BS) and a mobile or user equipment (UE). An example protocol in UMTS is the radio link control (RLC) protocol which is intended to segment service data units (SDUs) (e.g., larger sized packets) into packet data units (PDUs) (e.g., smaller fixed-sized packets) for transmission. PDUs contain sequence numbers (SNs) and length indicators (LIs). The SNs of the PDUs allow a receiver (e.g., UE, BS, etc.) to determine whether all of the PDUs in a sequence have been received. In other words, if PDUs with non-consecutive SNs are received consecutively, the receiver may determine that at least one PDU is lost and send a negative acknowledgement (NAK).

Each PDU may include one or more LIs. Each LI represents the number of bytes in a SDU portion of the PDU. For example, if a PDU includes a 10 byte portion associated with a larger SDU (i.e., including more than 10 bytes), the LI in the PDU is 10. Characteristics of the LI may indicate information associated with the PDU, SDU and/or SDU portion to the receiver. If the PDU includes more than one LI, each LI other than the last LI indicates a SDU portion which completes a SDU, where a completed SDU means that the receiver does not require any additional PDUs to reassemble the SDU. Likewise, each LI other than the first LI indicates a SDU portion which begins a new SDU, the new SDU possibly requiring additional PDUs with corresponding SDU portions to complete the new SDU.

Each LI that is neither first nor last corresponds to a complete SDU. However, the reverse is not necessarily true. The first LI in a PDU may or may not correspond to the beginning of a SDU and the last LI in a PDU may or may not correspond to an end of a SDU.

LIs may be set to special values (i.e., not representative of a SDU portion size) in order to indicate special information to the receiver. For example, special values for LIs may include a value which is greater than the maximum number of bytes in its SDU. Another example of a special value for LIs is zero; namely because SDUs with a length of zero are not allowed.

Special values may be used to indicate information associated with the PDU including the LI and/or with the SDU or SDU portion designated by the LI. The information may indicate that a SDU is complete, that a previous PDU included the last SDU portion for a completed SDU but did not include enough room for the appropriate indicator, control information, etc. It is worth noting that when the LI indicates that the PDU includes control information, each LI received in a previous PDU completes its respective SDU.

The RLC protocol schedules each of the PDUs associated with a given SDU for transmission. If a PDU is lost during transmission, the RLC layer schedules the lost PDU for retransmission. When all PDUs associated with a SDU are received at a receiver (e.g., UE, BS, etc.) (e.g., as indicated by a LI), the SDU may be reassembled.

In a communications network, data packets may be transferred from the UE (e.g., a mobile station) to a BS or from the BS to the UE. When the UE receives data packets from the BS, the UE is the receiver and the BS is the transmitter. Alternatively, when the BS receives data packets from the UE, the BS is the receiver and the UE is the transmitter.

During data packet transfer, the receiver sends status reports back to the transmitter. The status reports indicate which PDUs were successfully received and which were not. For example, the status report may contain an acknowledgement (ACK) for a sequence number n which indicates that all PDUs with an associated sequence number less than n were successfully received. Alternatively, the status report may include a NAK. The NAK may include either a list or a range of sequence numbers for PDUs which require retransmission (e.g., because the PDUs were not received or included errors).

One conventional method of triggering a status report is to send the status reports at established intervals. The intervals may be determined by a periodic timer at the receiver. Thus, for each period of the periodic timer, a status report may be sent from the receiver to the transmitter.

Another conventional method of triggering a status report is in response to a ‘poll bit’ in a received PDU. When the transmitting side desires feedback from the receiver, the poll bit is set. When the receiving end decodes the PDU including the poll bit, the receiver sends a status report to the transmitter if the poll bit so indicates. However, if a PDU including the poll bit is lost or received in error, the receiver may not send the status report.

Yet another conventional method of triggering a status report is when the receiver determines that a PDU is received out of sequence. For example, if a first received PDU contains a sequence number of “8”, and a second received PDU contains a, sequence number of “10”, the receiver determines that the PDU containing the sequencing number of “9” was lost in transmission. The receiver then generates a status report including a NAK for the missing PDU with the sequence number “9”.

In any of the above-described conventional methods, when a last PDU associated with an SDU is lost, the status report is only sent at the interval established by the periodic timer. Typically, the periodic timer may be set to a relatively long interval in order to avoid excessive status report transmissions. Thus, data transfer may experience additional delays (e.g., the reassembly of an SDU, the retransmission of the lost PDU, etc.) when a last PDU associated with an SDU is lost.

### SUMMARY OF THE INVENTION

In an embodiment of the present invention, a first type of data packet is received. The first type of data packet is at least a portion of a second type of data packet. Based on the received first type of data packet, a determination is made as to whether to expect receipt of a subsequent first type of data packet in a given time interval (e.g., a number of TTIs). A status signal is sent if the subsequent first type of data packet is not received in the given time interval as determined in the determining step.

In another embodiment of the present invention, data is received at a physical layer over a circuit-switched physical channel. At the physical layer, a determination is made as to whether a data packet has been correctly received, incorrectly received, or whether no data packet was received. A status report is sent to a higher protocol layer based on the determination.

### BRIEF DESCRIPTION OF THE DRAWINGS

FIG. 1 illustrates a block diagram of a cellular communications system for mobile devices including an integrated base station according to an example embodiment of the present invention.

FIG. 2 is a block diagram illustrating an integrated base station according to another example embodiment of the present invention.

FIG. 3 illustrates a process of handling packet data units (PDUs) according to another example embodiment of the present invention.

FIG. 4 illustrates a communication flow diagram of handling data packets according to another example embodiment of the present invention.

### DETAILED DESCRIPTION OF THE INVENTION

In order to better understand the present invention, examples of integrated base stations will be described. This will be followed by a description of example methodologies of the present invention implemented at integrated base stations.

### FIRST EXAMPLE INTEGRATED BASE STATION

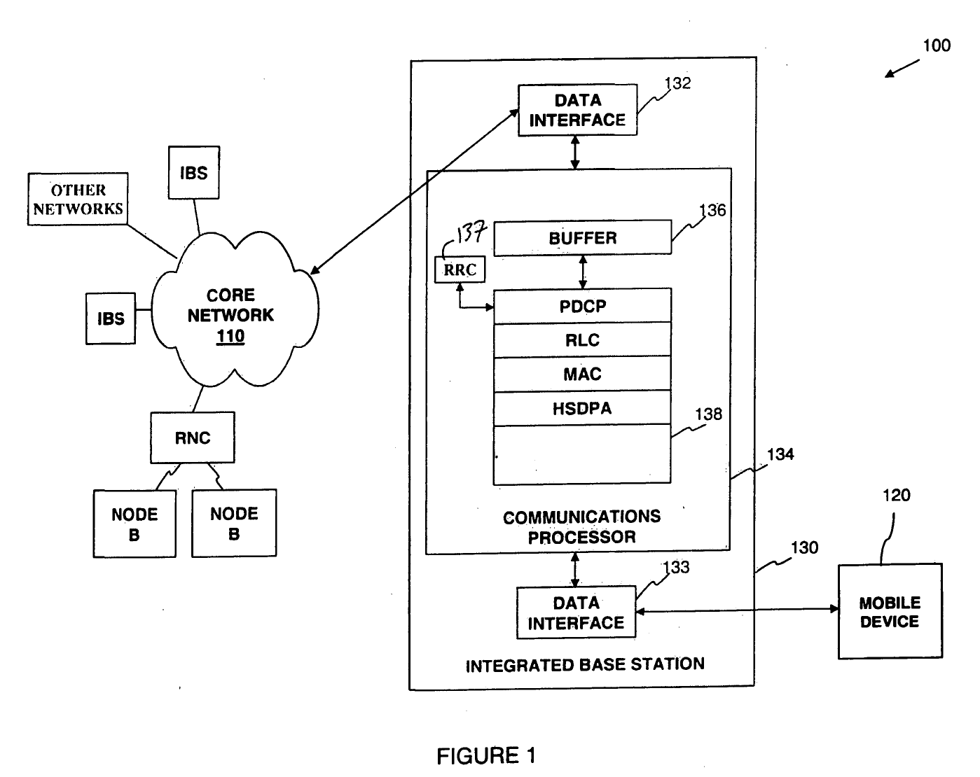

FIG. 1 illustrates a block diagram of a cellular communications system 100 for mobile devices including an integrated base station 130 according to an example embodiment of the present invention. The communications system 100 also includes a core network 110 and a mobile device 120.

The communications system 100 may be a conventional communications system such as a Universal Mobile Telecommunications System (UMTS) having multiple communications nodes coupled through wireless or wired mediums. Of course, the communications system 100 may be another type of communications system, such as, a Global System for Mobile Communications (GSM). Thus, one skilled in the art will understand that the discussion regarding a UMTS also applies to other cellular communications systems and components. For ease of discussion, the integrated base station 130 is representative of the other integrated base stations that are illustrated. One skilled in the art will also understand that the communications system 100 may include additional components or systems that are not illustrated or discussed, but are typically employed in a conventional communications system.

The core network 110 may be a conventional core network configured to handle voice and (IP) back-haul. The core network 110 includes communication nodes or switches coupled via connection lines. As illustrated, the core network 110 connects the integrated base station 130 to other integrated base stations and conventional RNCs and Node Bs. Additionally, the core network 110 can provide gateways to other networks (ISDN, Internet, etc.).

The mobile device 120 may be a conventional cellular telephone configured to operate in the communications system 100. Thus, the mobile device 120 may be a UMTS enabled cellular telephone. One skilled in the art will also understand that the mobile device 120 may also be another wireless device that is configured to operate in the communications system 100, such as, a personal digital assistant (PDA), a computer, an MP3 player, etc.

The integrated base station 130 is coupled to the core network 110 via a wired connection and to the mobile device 120 via a wireless connection. The integrated base station 130 is configured to include the functionality of a conventional RNC and a conventional Node B in a single processing entity. The integrated base station 130 includes a first data interface 132, a second data interface 133 and a communications processor 134 having a protocol stack 138, a buffer 136 and a Radio Resource Control (RRC) layer 137. One skilled in the art will understand that the integrated base station 130 includes additional components or features that are not material to the present invention but are typically employed in a conventional RNC or Node B to transmit data units between a core network and a mobile device.

The first data interface 132 is configured to transmit and receive data units from the core network 110, and the second data interface 133 is configured to transmit and receive data units from the mobile device 120. The first data interface 132 includes conventional components to transmit and receive data units over a wired connection to the core network 110, and the second data interface 133 includes conventional components to transmit and receive data units over a wireless connection to the mobile device 120. One skilled in the art will understand the operation and configuration of the first data interface 132 and the second data interface 133.

The communications processor 134 is configured to process data units from the first data interface 132 and the second data interface 133. The buffer 136 is configured to queue data units from the core network 110 for the protocol stack 138. In FIG. 1, the buffer 136 is located on top of the protocol stack 138.

The protocol stack 138 is configured to produce data units suitable for direct transmission to the mobile device 120. Thus, the protocol stack 138 provides a single location that receives data units from the core network 110 and transmits the data units with the proper protocols to the mobile device 120. The protocol stack 138 includes a Packet Data Convergence Protocol (PDCP) layer, a Radio Link Control (RLC) layer, a Media Access Control (MAC) layer, and a High Speed Downlink Packet Access (HPSPA) layer. Of course, one skilled in the art will understand that the protocol stack 138 may include other or additional protocol layers in other embodiments. In some embodiments, the HPSPA layer may not be included in the protocol stack 138. Additionally, considering a CDMA2000 system, the protocol stack 138 may be extended to include such layer-2 protocol functionality as point-to-point protocol (PPP) layer and radio link protocol (RLP) layer instead of the PDCP layer and the RLC layer that is associated with a UMTS.

### SECOND EXAMPLE INTEGRATED BASE STATION

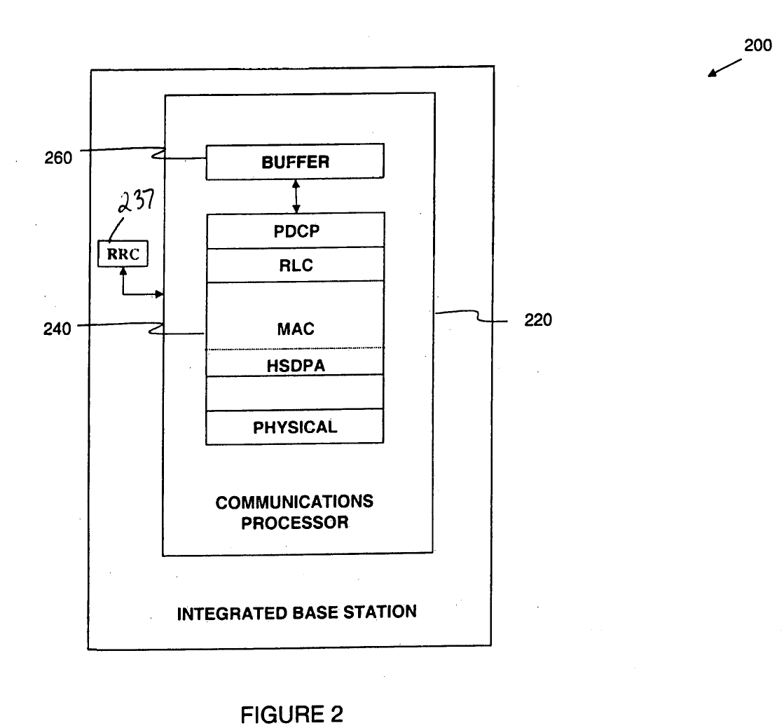

FIG. 2 is a block diagram illustrating an integrated base station 200 according to another example embodiment of the present invention. The integrated base station 200 includes a Radio Resource Control (RRC) layer 237 and a communications processor 220 having a protocol stack 240 and a buffer 260. Similar to FIG. 1, the RRC layer may be included within a communications processor in some embodiments.

The communications processor 220 is configured to process data units received over a communications network for mobile devices. More specifically, the communications processor 220 is configured to provide the needed protocols for transmitting a data unit between a core network and a mobile device. One skilled in the art will understand that the communications processor 220 includes additional components that are not material to the invention and are not illustrated or discussed.

The protocol stack 240 includes a PDCP layer, a RLC layer, a MAC layer and a physical layer. The physical layer may interpret signals on a circuit switched physical channel (e.g., a dedicated physical channel (DPDCH)). Integrated within the MAC layer is the functionality of a HSDPA layer. Thus, the MAC layer is configured to perform independent transmission decisions based on channel conditions to a wireless device. Of course, as illustrated in FIG. 1, a HSDPA layer can be interposed between the MAC layer and the physical layer. Additionally, in other cellular communications systems, the MAC layer may have other packet schedule modes integrated therein. For example, in a CDMA2000 system, the MAC layer may include the functionality of a DO or DV layer.

The buffer 260 may be a conventional buffer configured to queue data units between a wired and wireless channel. The buffer 260 is located on top of the protocol stack 240. Positioning the buffer 260 above the PDCP layer allows the buffer 260 to queue uncompressed data units. Thus, the buffer 260 may be positioned between the IP (not shown) and PDCP layers to provide a single queue for data units. The buffer 260 is configured to match speed differences between the wired and wireless domains.

### EXAMPLE METHODOLOGIES

Example methodologies of data packet transfer will now be described with reference to the above-described integrated base stations 130/200. It is understood that the methods of data packet transfer according to other example embodiments may be implemented with base stations other than the above-described integrated base stations 130/200.

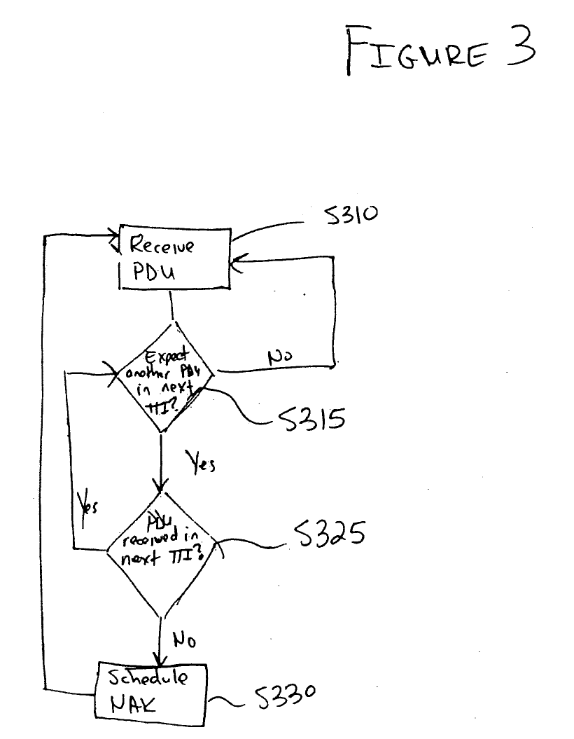

FIG. 3 illustrates a process of handling packet data units (PDUs) according to another example embodiment of the present invention. As discussed above, the RLC protocol segments SDUs (e.g., larger sized packets) into PDUs (e.g., smaller fixed sized packets) for transmission. The PDUs contain sequence numbers (SNs) and length indicators (LIs). The SN of a PDU allows a receiver (e.g., UE, BS, etc.) to determine whether all the PDUs for a sequence have been received. In other words, if PDUs with non-consecutive SNs are received consecutively, the receiver may determine that at least one PDU is lost and send a negative acknowledgement (NAK). As previously discussed, the LI in a PDU may indicate the end of an SDU. A plurality of PDUs may be reassembled at a receiver to reassemble a segmented SDU after all PDUs associated with the SDU are received.

Referring to FIG. 3, in step S310, a PDU is received. In step S315, the integrated base station 130/200 determines whether to expect a subsequent PDU. If the received PDU is the last PDU required to reassemble the SDU then the integrated base station 130/200 may not expect additional PDUs. The integrated base station 130/200 determines a PDU is the last PDU to reassemble an SDU when the LI so indicates. In this example, when no additional PDUs are expected, the process returns to step S310 and the integrated base station waits for a next received PDU.

If the LI for the PDU indicates more PDUs are needed to reassemble an SDU, the integrated base station 130/200 determines that additional PDUs are expected because the received PDU is not the last PDU associated with the SDU.

According to this embodiment of the present invention, the integrated base station 130/200 expects at least one of the additional PDUs in a next transmission interval (TTI). The TTI refers to an interval (e.g., 10 ms, 20 ms, 40 ms, 80 ms, etc.) where a radio frame may be received. Each radio frame may include a given number of PDUs (e.g., 0, 1, 2, 4, 8, 12, etc.).

In step S325, at the next TTI, the integrated base station 130/200 analyzes the radio frame. The integrated base station 130/200 determines if the radio frame includes at least one expected PDU (e.g., the next PDU in the sequence) without an error. If the expected PDU is not received in the next TTI, the integrated base station 130/200 determines that the expected PDU is lost. For example, the integrated base station 130/200 may determine that the expected PDU is not received if there are no PDUs within the radio frame. In another example, the integrated base station 130/200 may determine that the expected PDU is not received if the radio frame includes PDUs that do not have the next expected SN.

If the integrated base station 130/200 determines that the expected PDU is not received in the next TTI, the process advances to step S330. Otherwise, the process returns to step S315.

In step S330, the integrated base station 130/200 schedules a status report including a NAK for the next expected PDU. Once transmitted and received by the mobile device 120, the NAK will prompt the mobile device 120 to resend the next expected PDU.

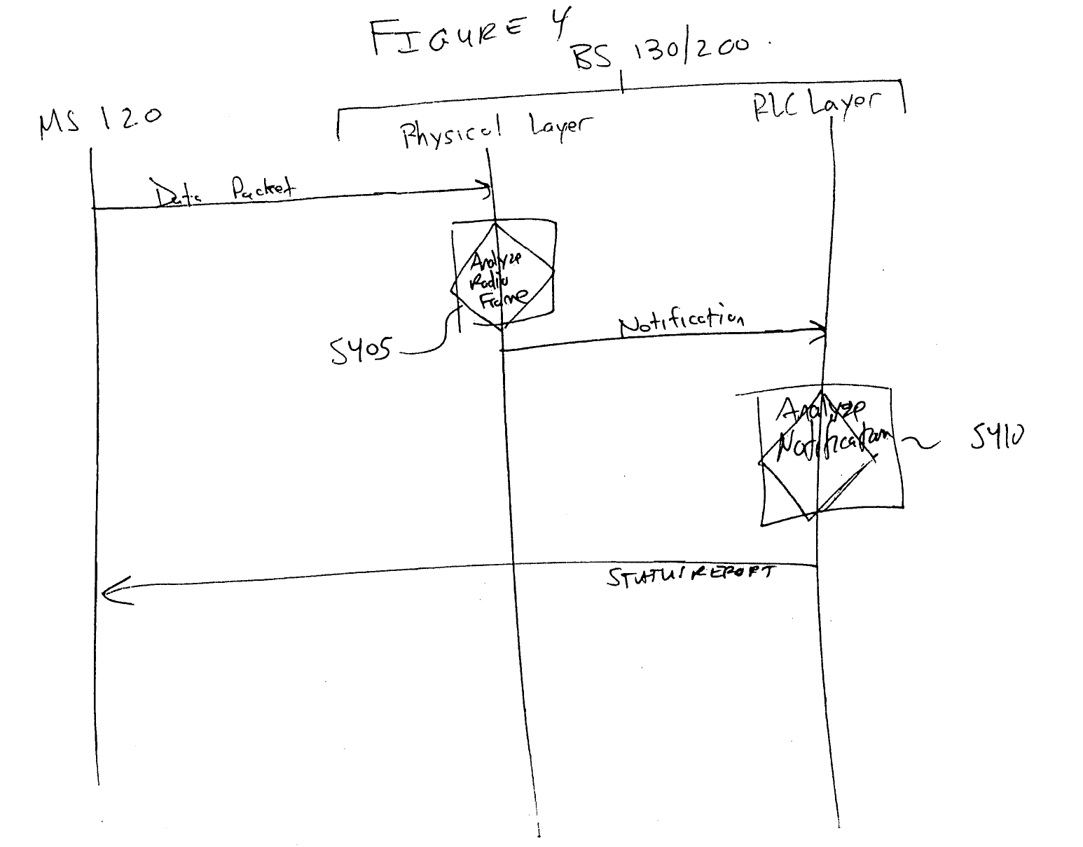

FIG. 4 illustrates a communication flow diagram of handling data packets according to another example embodiment of the present invention.

As shown, the mobile device 120 sends a PDU to the integrated base station 130/200. The PDU is received at the physical layer of the integrated base station 130/200 on a DPDCH. The physical layer analyzes the radio frame including the PDU in step S405. Based on the analysis in step S405, the physical layer determines whether to send a notification (e.g., a status report regarding the DPDCH, the received PDU, etc.) regarding the radio frame to the RLC layer of the integrated base station 130/200. If the radio frame includes at least one PDU which may be decoded correctly (e.g., because check-sum bits match), the notification is simply a delivery of the PDU to the RLC layer. For example, a base band decoder at the physical layer of the integrated base station 130/200 may determine that the cyclic redundancy checksum (CRC) bits indicate that the PDU does not include errors.

If the radio frame includes data packets which cannot be decoded correctly (e.g., check-sum bits do not match), the notification sent from the physical layer to the RLC layer is a checksum-error notification. For example, the base band decoder at the physical layer of the integrated base station 130/200 may determine that the checksum bits indicate that the PDU includes CRC errors.

If the integrated base station 130/200 determines that the radio frame includes no data packets, the physical layer does not send the notification. If the integrated base station 130/200 determines that the channel is down (e.g., no decodable data packets have been received for a given period of time), the notification is a channel-down notification. If the physical layer sends the channel-down notification, the physical layer continues to decode radio frames until a data packet is successfully received. When a data packet is received after the channel-down notification is sent to the RLC layer, the physical layer sends a channel-up notification to the RLC layer.

In step S410, the RLC layer analyzes the notification received from the physical layer. The RLC layer determines whether to send a status report to the mobile device 120 based on the analysis of the received notification. If the notification is a delivery of the data packet, then no status report is triggered. If the notification is a check-sum error notification, a status report may be triggered. In this case, the status report includes either a NAK for the PDU including the missing SN(s) or an ACK for the highest SN received. If no notification is received, the RLC layer does not trigger a status report. If the notification is a channel-down notification, the RLC layer waits until a channel-up notification is received from the physical layer. When the channel-up notification is received, the RLC layer schedules the status report.

The example embodiments of the present invention being thus described, it will be obvious that the same may be varied in many ways. For example, while the above described example methodologies have been given with respect to communication between the integrated base station 130/200, it is understood that other example embodiments of the present invention may be employed in any system where layer protocols may be capable of communication. Further, while the integrated base station 130/200 in the above described example embodiments has been described as communicating with a mobile station or UE, it is understood that in other example embodiments any device capable of communication on a wireless and/or wired communication network may be employed in communication with the integrated base station 130/200. Such variations are not to be regarded as a departure from the spirit and scope of the exemplary embodiments of the invention, and all such modifications as would be obvious to one skilled in the art are intended to be included within the scope of the following claims.

We claim:

1. A method of communication, comprising:
receiving a first type of data packet, the first type of data packet being at least a portion of a second type of data packet;
determining whether to expect receipt of a subsequent first type of data packet in a given time interval based on the received first type of data packet; and
sending a status signal if the subsequent first type of data packet is not received in the given time interval as determined in the determining step.

2. The method of claim 1, wherein the determination and sending steps are not performed when the received first type of data packet includes a last portion of the second type of data packet.

3. The method of claim 1, wherein the first type of data packet is a Universal Mobile Telecommunications System (UMTS) Radio Link Control (RLC) Packet Data Unit (PDU) and the second type of data packet is a UMTS RLC layer service data unit (SDU).

4. The method of claim 1, wherein the determining step determines whether to expect receipt of the subsequent first type of data packet based on an indicator in the received first type of data packet, the indicator indicating whether the received first type of data packet is a last portion of the second type of data packet.

5. The method of claim 4, wherein the sending step sends the status signal if the determining step determines that the indicator indicates the received first type of data packet does not include a last portion of the second type of data packet and the subsequent first type of data packet is not received in the given time interval.

6. The method of claim 5, wherein the given time slot is a next available time slot after the receipt of the received first type of data packet.

7. A method of communication, comprising:
receiving a data packet, at a physical layer, over a circuit switched physical channel;
determining a status of the data packet at the physical layer; and
sending a status report to a radio link control (RLC) layer based on the determination.

8. The method of claim 7, wherein one of a base station and user equipment (UE) performs the receiving, determining and sending steps.

9. The method of claim 7, wherein
the determining step determines if the received data packet can be properly decoded; and
the sending step sends the status report indicating that the received data packet was received in error if the determining step determines that the received data packet cannot be properly decoded

10. The method of claim 9 wherein the sending step does not send the status report when the determining step determines that the received data packet can be properly decoded.

11. The method of claim 7, wherein the circuit switched physical channel is a dedicated physical data channel (DPDCH).

12. A method of communication, comprising:
determining, at a radio link control (RLC) layer, a status of the circuit switched physical channel; and
sending, from the RLC layer, a status report based on the determination.

13. The method of claim 12, wherein the circuit switched physical channel is a dedicated physical data channel (DPDCH).
